(19) United States
(12) Patent Application Publication
(10) Pub. No.: US 2012/0263225 A1
(43) Pub. Date: Oct. 18, 2012

(54) APPARATUS AND METHOD FOR ENCODING MOVING PICTURE

(75) Inventor: Jeyun LEE, Incheon-city (KR)

(73) Assignee: MEDIA EXCEL KOREA CO. LTD., Seoul (KR)

(21) Appl. No.: 13/087,514

(22) Filed: Apr. 15, 2011

(51) Int. Cl. H04N 7/26

(52) U.S. Cl. 375/240.2; 375/240.01; 375/240.24; 375/E07.2

(57) ABSTRACT

An apparatus and method for encoding a moving picture. Since the apparatus includes a plurality of central processing units (CPUs), the apparatus may perform parallel encoding even for a H.264 video encoder having high complexity. In particular, since the apparatus still uses information about blocks around a macroblock even at a boundary of a slice, the apparatus may improve the efficiency of a video codec.

### BACKGROUND OF THE INVENTION

1. Field of the Invention

The present invention relates to an apparatus and method for encoding a moving picture.

2. Description of the Related Art

In general, since video data is larger in size than text data or audio data, the video data needs to be compressed when being stored or transmitted. A video codec is a device for compressing and decompressing video data. Video codecs satisfying various standards such as MPEG-1, MPEG-2, H.263, and H.264/MPEG-4 are widely used.

From among the standards, since the H.264 standard provides an excellent compression ratio and image quality, the H.264 standard is used in various fields including mobile television (TV), the Internet, web TV, and cable TV. However, since the H.264 standard is very complex compared to the MPEG-4 standard, it is difficult to implement a H.264 codec by using a single central processing unit (CPU) or a single core processor.

### SUMMARY OF THE INVENTION

The present invention provides an apparatus and method for encoding a moving picture by using a plurality of central processing units (CPUs) or cores.

According to an aspect of the present invention, there is provided an apparatus for encoding a moving picture, the apparatus including: at least two processors which encode a source image of the moving picture; wherein the at least two processors include: a first processor which encodes a first slice obtained by dividing the source image to output a first encoding stream, and generates a first reconstructed image obtained by reconstructing the first slice; and a second processor which encodes a second slice obtained by dividing the source image to output a second encoding stream, and generates a second reconstructed image obtained by reconstructing the second slice, wherein the first processor and the second processor encode the source image in parallel.

When a first time taken for the first processor to generate the first reconstructed image elapses, the second processor may encode the second slice by using the first reconstructed image.

The first processor may extract image information about a boundary with the second slice from the first reconstructed image and transmits the extracted image information to the second processor, and the second processor may extract image information about a boundary with the first slice from the second reconstructed image and transmits the extracted image information to the first processor.

The first processor may encode a next source image by using the image information transmitted from the second processor and the first reconstructed image, and the second processor may encode the next source image by using the image information transmitted from the first processor and the second reconstructed image.

The apparatus may further include a third processor which encodes a third slice obtained by dividing the source image to output a third encoding stream, and generates a third reconstructed image obtained by reconstructing the third slice, wherein the second processor extracts image information about a boundary with the third slice from the second reconstructed image and transmits the image information to the third processor, and the third processor extracts image information about a boundary with the second slice from the third reconstructed image and transmits the image information to the second processor.

The second processor may encode the next source image by using the image information transmitted from the first processor and the second reconstructed image, and the image information transmitted from the third processor.

The image information about the boundaries may be image information of an area in a search range for estimating a motion in the first processor and the second processor.

The image information about the boundaries may be image information about an area including an area including the search range and an area including at least three pixels for subpixel motion estimation.

The first processor and the second processor may encode the moving image according to H.264.

When the first time elapses, the first processor may transmit image information about a macroblock at a boundary with the second slice included in the first reconstructed image to the second processor.

The second processor may encode the boundary with the second slice by using the image information.

According to another aspect of the present invention, there is provided a method of encoding a source image of a moving picture by using an apparatus for encoding a moving picture including at least two processors, the method including: dividing the source image into at least two slices; encoding a first slice obtained by dividing the source image to output a first encoding stream and generating a first reconstructed image obtained by reconstructing the first slice; and encoding a second slice obtained by dividing the source image to output a second encoding stream and generating a second reconstructed image obtained by reconstructing the second slice, wherein the encoding of the first slice and the encoding of the second slice are performed in parallel.

The encoding of the second slice may include, when a first time taken to generate the first reconstructed image elapses, encoding the second slice by using the first reconstructed image.

According to another aspect of the present invention, there is provided a non-transitory computer-readable recording medium having embodied thereon a program for executing the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional apparatus for encoding a moving picture according to H.264;

FIG. 2 is a block diagram for explaining an operation of an apparatus for encoding a moving picture according to an embodiment of the present invention;

FIG. 3 is a diagram for explaining image information about a boundary according to an embodiment of the present invention;

FIG. 4 is a block diagram for explaining an operation of an apparatus for encoding a moving picture according to another embodiment of the present invention; and

FIG. 5 is a block diagram for explaining an operation of an apparatus for encoding a moving picture according to another embodiment of the present invention.

### DETAILED DESCRIPTION OF THE INVENTION

The present invention will now be described more fully with reference to the accompanying drawings, in which exemplary embodiments of the invention are shown. Only essential parts for understanding the operation of the present invention will be described and other parts may be omitted in order not to make the subject matter of the present invention unclear.

Also, terms or words which are used in the present specification and the appended claims should not be construed as being confined to common meanings or dictionary meanings but should be construed as meanings and concepts matching the technical spirit of the present invention in order to most describe the present invention in the best fashion.

A general video codec compresses/encodes video data by removing spatial redundancy and temporal redundancy in an image and displays the video data as a bitstream with a much shorter length. For example, a video codec removes spatial redundancy in an image by removing through discrete cosine transformation (DCT) and quantization a high frequency component, which accounts for a large part of the image data and to which human eyes are not sensitive. Also, the video codec removes temporal redundancy, that is, a similarity between frames, by detecting the similarity between the frames and transmitting motion vector information and an error component generated when a motion is expressed with a motion vector, without transmitting data of a similar portion. Also, the video codec reduces the amount of transmitted data by using a variable-length code (VLC) which maps a short code value to a bit string that frequently occurs.

The video codec processes data in units of blocks including a plurality of pixels, for example, in units of macroblocks (MBs) when compressing/encoding and decoding an image. For example, when compressing/encoding an image, the video codec performs a series of steps such as DCT and quantization in units of blocks. However, when the compressed/encoded image that has gone through these steps is reconstructed, distortion due to blocking is inevitably caused. Here, blocking refers to visually objectionable artificial frontiers between blocks in a reconstructed image, which occur due to loss of portions/pixels of an input image during the quantization or a pixel value difference between adjacent blocks around a block boundary.

Accordingly, in order to prevent distortion due to blocking during compression/encoding or decoding of an image, a deblocking filter is used. The deblocking filter may improve the quality of a reconstructed image by smoothing a boundary between macroblocks to be decoded. A frame image processed by the deblocking filter is used for motion compensated prediction of a future frame or is transmitted to a display device to be reproduced.

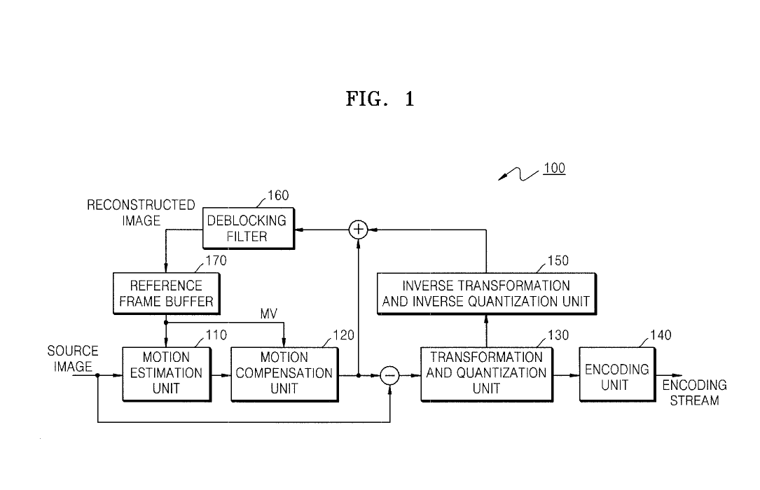

FIG. 1 is a block diagram of a conventional apparatus 100 for encoding a moving picture.

Referring to FIG. 1, the conventional apparatus 100 includes a motion estimation unit 110, a motion compensation unit 120, a transformation and quantization unit 130, an encoding unit 140, an inverse transformation and inverse quantization unit 150, a deblocking filter 160, and a reference frame buffer 170. Here, the term ‘apparatus for encoding a moving picture’ is not construed as being confined, and examples of the apparatus for encoding the moving picture include a moving picture encoder, a video encoder, and a video codec. Although an explanation is given based on H.264, which is a video coding standard, the present invention is not limited thereto. Also, a source image input to the conventional apparatus 100 is processed in units of macroblocks, and each of the macroblocks may include 16×16 luminance samples and related chrominance samples.

The motion estimation unit 110 searches for a block that is most similar to a source image.

The motion compensation unit 120 reads a portion indicated by a motion vector in the reference frame buffer 170. This process is called motion compensation. A previously encoded frame is stored in the reference frame buffer 170. The transformation and quantization unit 130 transforms and quantizes a difference between the source image and a motion compensated image. The transformation may be performed by using DCT.

The encoding unit 140 entropy encodes a coefficient of each of the macroblocks, a motion vector, and related header information and outputs a compressed stream. The entropy encoding may be performed by using VLC.

The inverse transformation and inverse quantization unit 150 inversely transforms and inversely quantizes the transformed and quantized difference to produce a predicted error. The predicted error is added to the motion compensated image, and the deblocking filter 160 generates a reconstructed image. The reconstructed image is input to the reference frame buffer 170 and is used as a reference image of subsequent input source images. The deblocking filter 160 is applied to each decoded macroblock in order to reduce distortion due to blocking. On an encoder side, the deblocking filter 160 is used before a macroblock is reconstructed and stored for future prediction. On a decoder side, the deblocking filter 160 is used after a macroblock is reconstructed and inverse transformation is performed before display or transmission. The deblocking filter 160 improves the quality of a decoded frame by smoothing edges of a block. A filtered image may be used for motion compensated prediction of a future frame. Since the filtered image is reconstructed to be more similar to an original frame than a non-filtered image having blocking, compression performance is improved.

The aforesaid encoding and reconstructed image generation may be performed according to MPEG-4, MPEG-2, or H.263, rather than according to H.264.

Meanwhile, the video coding methods improve compression performance by using information about blocks around a macroblock. In particular, the H.264 standard has greatly improved performance because it uses information about blocks around a macroblock. However, since information about blocks around a macroblock should be used, dependency on neighboring macroblocks occurs when a macroblock is coded. That is, in order to code a current macroblock, neighboring macroblocks should already be coded. Such dependency is an obstacle to parallel encoding, which refers to simultaneous encoding, and particularly, is an obstacle to parallel encoding according to the H.264 standard, which has high complexity.

Meanwhile, the H.264 standard provides a slice mode for parallel encoding and thus allows parallel encoding by removing data dependency between slices. However, once the slice mode is used, since information about neighboring macroblocks at a boundary between slices may not be used, encoding efficiency is reduced.

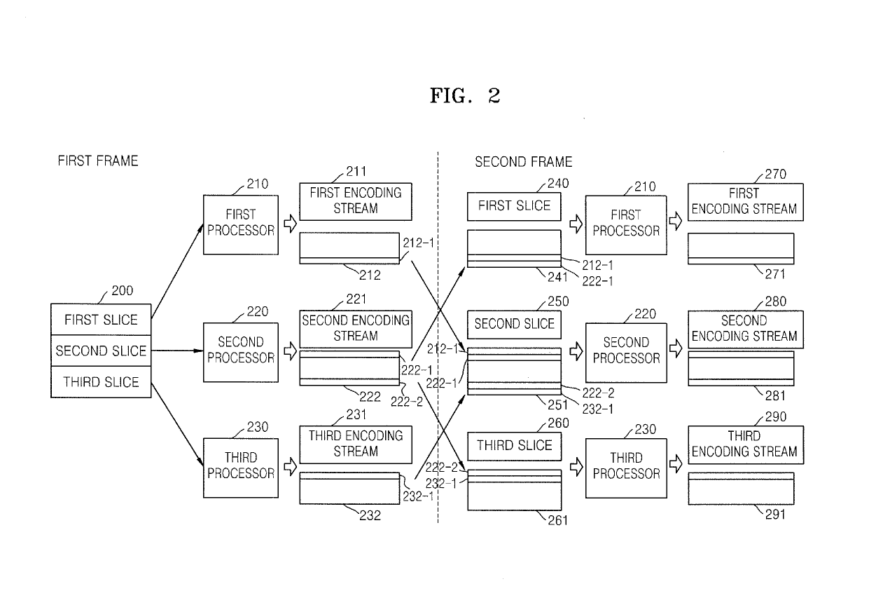

FIG. 2 is a block diagram for explaining an operation of an apparatus for encoding a moving picture according to an embodiment of the present invention.

Referring to FIG. 2, the apparatus includes a first processor 210, a second processor 220, and a third processor 230. Each of the first through third processors 210 through 230 encodes a moving picture in parallel. Although three processors, that is, the first through third processors 210 through 230, are illustrated in FIG. 2, the present embodiment is not limited thereto.

A source image 200 of a first frame is divided into a first slice, a second slice, and a third slice, and the first processor 210, the second processor 220, and the third processor 230 respectively process the first slice, the second slice, and the third slice in parallel.

The first processor 210 encodes the first slice to output a first encoding stream 211, and generates a first reconstructed image 212 through a reconstruction process. The first processor 210 transmits image information 212-1 about a boundary between the second slice and the first reconstructed image 212 to the second processor 220.

The second processor 220 encodes the second slice to output a second encoding stream 221, and generates a second reconstructed image 222 through a reconstruction process. The second processor 220 transmits image information 222-1 about a boundary between the first slice and the second reconstructed image 222 to the first processor 210, and transmits image information 222-2 about a boundary between the third slice and the second reconstructed image 222 to the third processor 230.

The third processor 230 encodes the third slice to output a third encoding stream 231, and generates a third reconstructed image 232 through a reconstruction process. The third processor 230 transmits image information 232-1 about a boundary between the second slice and the third reconstructed image 232 to the second processor 220.

A source image of a second frame is divided into a first slice 240, a second slice 250, and a third slice 260, and the first processor 210, the second processor 220, and the third processor 230 respectively process the first slice 240, the second slice 250, and the third slice 260 in parallel.

The first processor 210 uses a reference slice 241 in order to encode the first slice 240. The reference slice 241 includes the first reconstructed image 212 obtained by reconstructing the first slice 240 and the image information 222-1 transmitted from the second processor 220. The first processor 210 outputs a first encoding stream 270 obtained by encoding the first slice 240 by using the reference slice 241, and generates a reconstructed image 271.

The second processor 220 uses a reference slice 251 in order to encode the second slice 250. The reference slice 251 includes the second reconstructed image 222 obtained by reconstructing the second slice 250, the image information 212-1 transmitted from the first processor 210, and the image information 232-1 transmitted from the third processor 230. The second processor 220 outputs a second encoding stream 280 obtained by encoding the second slice 250 by using the reference slice 251, and generates a reconstructed image 281.

The third processor 230 uses a reference slice 261 in order to encode the third slice 260. The reference slice 261 includes the third reconstructed image 232 obtained by reconstructing the third slice 260, and the image information 222-2 transmitted from the second processor 220. The third processor 230 outputs a third encoding stream 290 obtained by encoding the third slice 260 by using the reference slice 261, and generates a reconstructed image 291.

Due to the parallel encoding described above, the first through third processors 210 through 230 may improve compression performance by using information about a boundary of neighboring slices for encoding. The apparatus of FIG. 2 may solve the problem of data dependency which is caused when a deblocking filter performs filtering even at a slice boundary. Also, the apparatus of FIG. 2 may solve the problem of motion estimation beyond a boundary which is caused when a slice boundary for a reference frame is not specified during motion estimation between frames.

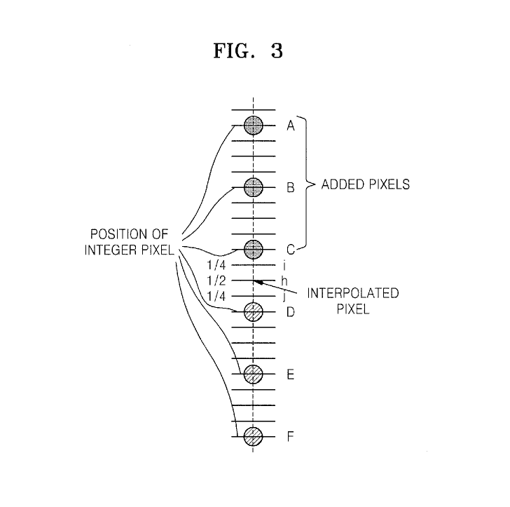

FIG. 3 is a diagram for explaining image information about a boundary according to an embodiment of the present invention.

As described above, since motion estimation may be performed beyond a slice boundary, each of processors should receive a reconstructed image of a predetermined area and then form a reference frame. A size of an area to be transmitted or copied to another processor may be defined by Equation 1 below.

Copy_size=Source_Width×(search_range+a) [Equation 1]

where a is an integer equal to or greater than 3.

Since a maximum distance in which motion estimation is performed beyond a slice boundary may not exceed a search range, each of processors receives reconstructed images from other processors in a minimum search range or search window. The reason why three or more pixels are added to the search range is to perform subpixel motion estimation. That is, subpixel motion estimation requires an interpolated reference frame, and six pixels in a vertical direction are required during interpolation. Also, since three or more pixels are added, communication between processors may be efficiently performed according to hardware characteristics or a specific data bus.

As shown in FIG. 3, in detail, the reason why three pixels are added is to cover a case where an upper or lower end of a search range becomes an optimal motion vector for integer pixel motion estimation. For example, if a pixel D is an upper end of a search range and a highest integer motion vector, subpixel motion estimation is performed again for the pixel D. Then, as shown in FIG. 3, h, I, and j are candidates for the subpixel motion estimation. However, if there exist only pixels in a search range, that is, if there exist only pixels D, E, and F, subpixel motion estimation may not be performed on h, i, and j. This is because, in order to obtain h, pixels A, B, and C are required, and in order to obtain i and j, h is required. Accordingly, the three pixels A, B, and C are additionally required. Although image information about a boundary in a vertical direction and a case where three or more pixels in a vertical direction are additionally required have been explained, if a slice is divided in a horizontal direction, that is, if image information about a boundary in a horizontal direction is to be transmitted to neighboring processors, three or more pixels may be additionally generated and transmitted as the image information about the boundary in the horizontal direction. Accordingly, according to the present embodiment, since image information about a slice boundary, that is, a reconstructed image of a predetermined area, is transmitted or copied, data dependency between slices, that is, processors, is removed and parallel encoding may be performed.

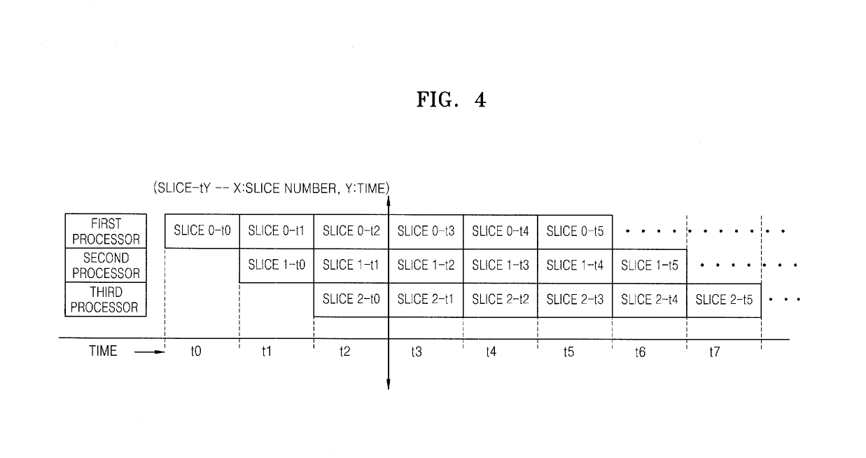

FIG. 4 is a block diagram for explaining an operation of an apparatus for encoding a moving picture according to another embodiment of the present invention.

Referring to FIG. 4, first through third processors perform encoding in parallel. After the second processor waits for an encoding result of the first processor, that is, after a first time elapses, the second processor receives image information about a slice boundary from the first processor or information about a macroblock, and performs encoding on a corresponding slice. That is, since a source image may be divided into a plurality of slices and there may be a delay between the slices, information about neighboring macroblocks may be used even at a slice boundary, and parallel processing may be simultaneously performed.

Referring back to FIG. 4, an input source image is divided into three slices, and three, that is, first through third, processors respectively encode the three slices in parallel. At a first time t0, only the first processor encodes a slice 0-t0, and the second processor and the third processor wait for an encoding result of the first processor. At a time t1, the first processor encodes a slice 0-t1, and the second processor encodes a slice 1-t0 by using the encoding result of the first processor. At a time t2, the first processor encodes a slice 0-t2, the second processor encodes a slice 1-t1, and the third processor encodes a slice 2-t0. Accordingly, at the time t2, when all of the first through third processors perform encoding in parallel, an encoding stream about a first input image is obtained.

Due to the afore-mentioned delay parallel encoding, after slice encoding, information about macroblocks of a slice boundary is transmitted to each of processors, and thus when a macroblock is encoded, information about blocks around the macroblock may be used. That is, although one image is encoded into a plurality of slices, when only a final stream is considered, a slice mode is not yet used. For reference, the number of slices used to encode one image may be obtained by using the number of slice headers included in a stream. That is, although encoding is performed by dividing an image into a plurality of slices, only one slice header exists in an output encoding stream.

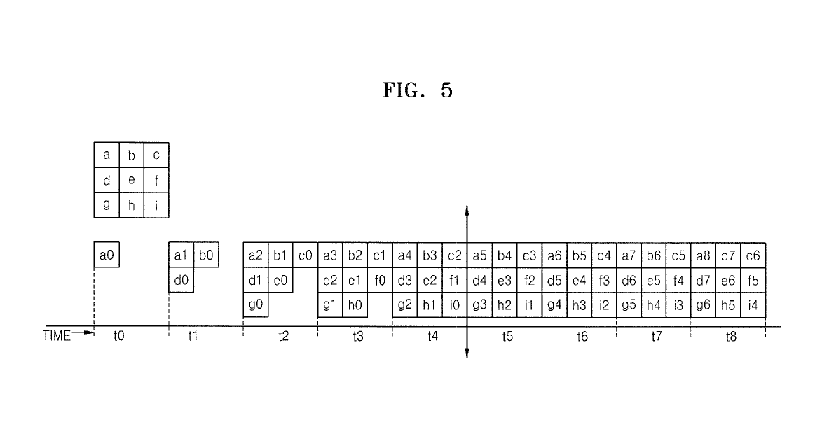

FIG. 5 is a diagram for explaining an operation of an apparatus for encoding a moving picture according to another embodiment of the present invention.

FIG. 5 illustrates another example of delay parallel encoding explained with reference to FIG. 4. An input image source is divided into nine areas, and nine processors process the nine areas sequentially. The nine processors are denoted by reference symbols a through i.

Referring to FIG. 5, at a time to, only the processor ‘a’ encodes an area a0, at a time t1, the processor ‘a’ encodes an area a1, the processor ‘b’ receives an a0 encoding result of the processor ‘a’ and encodes b0, and the processor ‘d’ receives the a0 encoding result and encodes d0. The remaining processors encode corresponding areas by using encoding results of neighboring processors. Accordingly, at a time t4, all of the nine processors perform encoding in parallel, and obtain an encoding stream about a first input source image. In this case, since data dependency occurs at a boundary between areas of the processors, information required by each of the processors should be transmitted. Although one image is encoded into nine areas, since only one slice header exists in an encoding stream, the same result as that when an entire image is encoded by one processor may be obtained.

The device described herein may include a memory for storing program data and a processor for executing it, a permanent storage such as a disk drive, a communications port for handling communications with external devices, and user interface devices, including a display, keys, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code may be stored and executed in a distributed fashion.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that are executed on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention.

As described above, since the apparatus for encoding the moving picture according to the one or more embodiments of the present invention includes a plurality of CPUs, the apparatus may perform parallel encoding even for a H.264 video encoder having high complexity. In particular, since the apparatus still uses information about neighboring blocks of a macroblock even at a slice boundary, the apparatus may improve the efficiency of a video codec.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for encoding a moving picture, the apparatus comprising:
at least two processors which encode a source image of the moving picture;
wherein the at least two processors comprise:
a first processor which encodes a first slice obtained by dividing the source image to output a first encoding stream, and generates a first reconstructed image obtained by reconstructing the first slice; and
a second processor which encodes a second slice obtained by dividing the source image to output a second encoding stream, and generates a second reconstructed image obtained by reconstructing the second slice,
wherein the first processor and the second processor encode the source image in parallel.

2. The apparatus of claim 1, wherein when a first time taken for the first processor to generate the first reconstructed image elapses, the second processor encodes the second slice by using the first reconstructed image.

3. The apparatus of claim 1, wherein the first processor extracts image information about a boundary with the second slice from the first reconstructed image and transmits the extracted image information to the second processor, and
the second processor extracts image information about a boundary with the first slice from the second reconstructed image and transmits the extracted image information to the first processor.

4. The apparatus of claim 3, wherein the first processor encodes a next source image by using the image information transmitted from the second processor and the first reconstructed image, and
the second processor encodes the next source image by using the image information transmitted from the first processor and the second reconstructed image.

5. The apparatus of claim 3, further comprising a third processor which encodes a third slice obtained by dividing the source image to output a third encoding stream, and generates a third reconstructed image obtained by reconstructing the third slice,
wherein the second processor extracts image information about a boundary with the third slice from the second reconstructed image and transmits the image information to the third processor, and
the third processor extracts image information about a boundary with the second slice from the third reconstructed image and transmits the image information to the second processor.

6. The apparatus of claim 5, wherein the second processor encodes the next source image by using the image information transmitted from the first processor and the second reconstructed image, and the image information transmitted from the third processor.

7. The apparatus of claim 3, wherein the image information about the boundaries is image information of an area in a search range for estimating a motion in the first processor and the second processor.

8. The apparatus of claim 7, wherein the image information about the boundaries is image information about an area comprising an area including the search range and an area including at least three pixels for subpixel motion estimation.

9. The apparatus of claim 1, wherein the first processor and the second processor encode the moving image according to H.264.

10. The apparatus of claim 2, wherein when the first time elapses, the first processor transmits image information about a macroblock at a boundary with the second slice included in the first reconstructed image to the second processor.

11. The apparatus of claim 10, wherein the second processor encodes the boundary with the second slice by using the image information.

12. A method of encoding a source image of a moving picture by using an apparatus for encoding a moving picture comprising at least two processors, the method comprising:
dividing the source image into at least two slices;
encoding a first slice obtained by dividing the source image to output a first encoding stream and generating a first reconstructed image obtained by reconstructing the first slice; and
encoding a second slice obtained by dividing the source image to output a second encoding stream and generating a second reconstructed image obtained by reconstructing the second slice,
wherein the encoding of the first slice and the encoding of the second slice are performed in parallel.

13. The method of claim 12, wherein the encoding of the second slice comprises, when a first time taken to generate the first reconstructed image elapses, encoding the second slice by using the first reconstructed image.

14. A non-transitory computer-readable recording medium having embodied thereon a program for executing the method of claim 12.

15. A non-transitory computer-readable recording medium having embodied thereon a program for executing the method of claim 13.
